(19) United States
(12) Patent Application Publication
(10) Pub. No.: US 2004/0259673 A1
(43) Pub. Date: Dec. 23, 2004

(54) Snowmboile pulley cover

(76) Inventors: Eric Bertrand, St-Eile-d'Oford (CA); Louis Lefebvre, Valcourt (CA)

Correspondence Address: BOMBARDIER RECREATIONAL PRODUCTS INC, INTELLECTUAL PROPERTY DEPT, PO BOX 230, NORTON, VT, 05907-0230, US

(21) Appl. No.: 10/871,527

(22) Filed: Jun. 21, 2004

Related U.S. Application Data
(60) Provisional application No. 60/479,469, filed on Jun. 19, 2003.

(51) Int. Cl. B62J 13/00

(52) U.S. Cl. 474/144

(57) ABSTRACT

A belt transmission system of a snowmobile includes a cover which has an upper cover portion and a side cover portion. The cover is pivotally mounted to the chassis of the snowmobile so that it can not only be conveniently installed or removed, but can also be pivotally opened to allow for access to the belt transmission system. The cover effectively prevents injury when the hood and side panel of fairings of the snowmobile are open. The cover further includes noise absorption material attached thereto. Thus, noise reduction is improved by better confining the noise produced by engagement of the belt with the pulleys within an inner space, and by partially absorbing the noise energy.

This application claims the benefit of priority to U.S. Provisional Application No. 60/479,469 filed on Jun. 19, 2003, the contents of which are incorporated herein by reference.

### FIELD OF THE INVENTION

The present invention generally relates to a snowmobile, and more particularly to a cover structure of a belt transmission system of a snowmobile.

### BACKGROUND OF THE INVENTION

A snowmobile generally includes an engine, a ski and steering assembly, a drive track assembly, a belt transmission system for transmitting power from the engine to the drive track assembly, and a chassis as a supporting base of the snowmobile. The belt transmission system includes an endless belt surrounding a pair of spaced-apart pulleys. The engine and the belt transmission system are enclosed within a fairing shell at a front portion of the snowmobile. The fairing shell usually includes a hood and at least one side panel which are openable to allow for inspection and maintenance of the engine and the belt transmission system.

In a belt-breaking accident, pieces of a broken belt could be thrown around due to the angular momentum of the turning belt, particularly if the hood or side panel of the snowmobile were open during such an occurrence, as is required under certain circumstances such as engine or belt transmission system inspection, maintenance, or the like.

Conventionally, a pulley cover which is an elongate and curved metal panel, is positioned above the belt and the pulleys in order to prevent pieces of a broken belt from being thrown around to potentially cause injury to persons. Conventional pulley covers also offer a certain amount of protection such that a person cannot easily place his/her hands on the turning belt or pulleys. The conventional pulley cover is conveniently mounted to the chassis of the snowmobile and can be completely removed. However, it is apparent that the protection provided by this type of conventional pulley covers can, in some circumstances, be limited. In particular, the conventional pulley cover cannot prevent catching clothing in the pulleys in all situations.

Efforts have been made to develop pulley covers offering better protection. For example, some prior art vehicles provide a pulley cover with a complete housing. However, while those pulley covers provide some protection they, are inconvenient to remove or open for allowing access to the belt transmission system when required. Therefore, there is a need for an alternative belt transmission system covering structure to address these problems.

### SUMMARY OF THE INVENTION

It is one object of the present invention to provide a belt transmission system cover structure for snowmobiles which not only helps to prevent accidental access to the belt transmission system while it is turning, but also conveniently allows for access to the belt transmission system when required.

In accordance with one aspect of the present invention, an apparatus for covering a belt transmission system which is operatively supported on a chassis of a snowmobile and includes an endless belt surrounding a pair of spaced apart pulleys, comprises an upper cover portion and a side cover portion. The upper cover portion is adapted for preventing access to the pulleys and belt from a top of the snowmobile. The side cover portion is attached to an outer side edge of the upper cover portion, extending downwardly therefrom, and is adapted for preventing access to the pulleys and belt from a side of the snowmobile. Means are positioned at an end of the upper cover portion for pivotally mounting the upper cover portion to the chassis, thereby permitting the upper and side cover portions to pivot away from the belt transmission system about an axis transverse to a longitudinal centerline of the snowmobile, when access to the pulleys and belt is required.

The pivotal mounting means preferably comprises a pin pivotally interconnecting a front end of the upper cover portion and a mounting portion of the chassis. The upper cover portion preferably comprises a locking device located at a rear end thereof for releasably securing the apparatus in a closed position.

The side cover portion preferably comprises a noise absorption structure. In one embodiment of the present invention the side cover portion includes a foam material attached to an inner side thereof.

In accordance with another aspect of the present invention, there is provided a snowmobile having an engine, a ski and steering assembly, a drive track assembly, a belt transmission system for transmitting power from the engine to the drive track assembly, and a chassis as a supporting base of the snowmobile. The snowmobile further comprises a belt transmission system cover including an upper cover portion and a side cover portion attached to an outer side edge of the upper cover portion and extending downwardly therefrom. Means are provided for pivotally mounting the belt transmission system cover at a front end of the upper cover portion, to the chassis, thereby permitting the belt transmission system cover to pivot about an axis transverse to a longitudinal centerline of the snowmobile, between a first position in which the upper cover portion is disposed above the belt transmission system and the side portion is disposed at an outer side of the belt transmission system, and a second position in which the belt transmission system cover is pivoted away from the first position allowing for access to the belt transmission system when required.

The snowmobile preferably comprises means for releasably securing the belt transmission system cover in the first position. The upper cover portion is preferably shaped to correspond with an upper contour of the belt transmission system. The side cover portion preferably includes a lower edge positioned at a bottom surface of the chassis when the belt transmission system cover is in the first position. It is also preferable that the snowmobile includes an external shell for enclosing the engine and belt transmission system and that the belt transmission system cover is disposed within the external shell.

The belt transmission system cover according to the present invention not only effectively helps to prevent pieces of a broken belt from being thrown around in a belt-breaking event but also effectively prevents injuries caused by people placing their hands or catching their clothing on the turning belt and pulleys, and further advantageously provides a simple structure for easy installation and convenient opening when access to the belt transmission system is required.

The present invention still further advantageously improves suppression of the noise produced by the belt transmission system.

Other features and advantages of the present invention will be better understood with reference to the preferred embodiment described hereinafter.

### BRIEF DESCRIPTION OF THE DRAWINGS

Having thus generally described the nature of the present invention, reference will now be made to the accompanying drawings by way of illustration showing a preferred embodiment, in which:

FIG. 1 is a schematic side view of a snowmobile incorporating one embodiment of the present invention;

FIG. 2 is a rear, side perspective view of a belt transmission system cover according to the embodiment of the present invention, incorporated in the snowmobile of FIG. 1;

FIG. 3 is a front, side perspective view of the belt transmission system cover of FIG. 2;

FIG. 4 is a partial perspective view of FIG. 1, with fairings of the snowmobile removed, showing the belt transmission system cover of FIG. 2 installed in position, with a side cover portion being partially cut away for illustrative purposes; and

FIG. 5 is a partial cross-sectional view of the side cover portion, showing a layer of foam material attached thereto.

### DETAILED DESCRIPTION OF THE PREFERRED EMBODIMENT

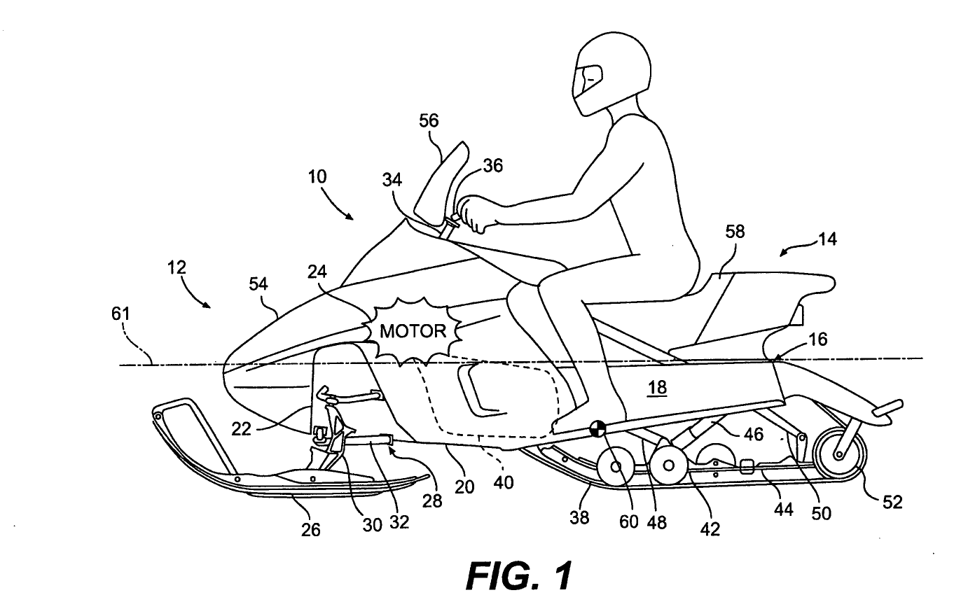

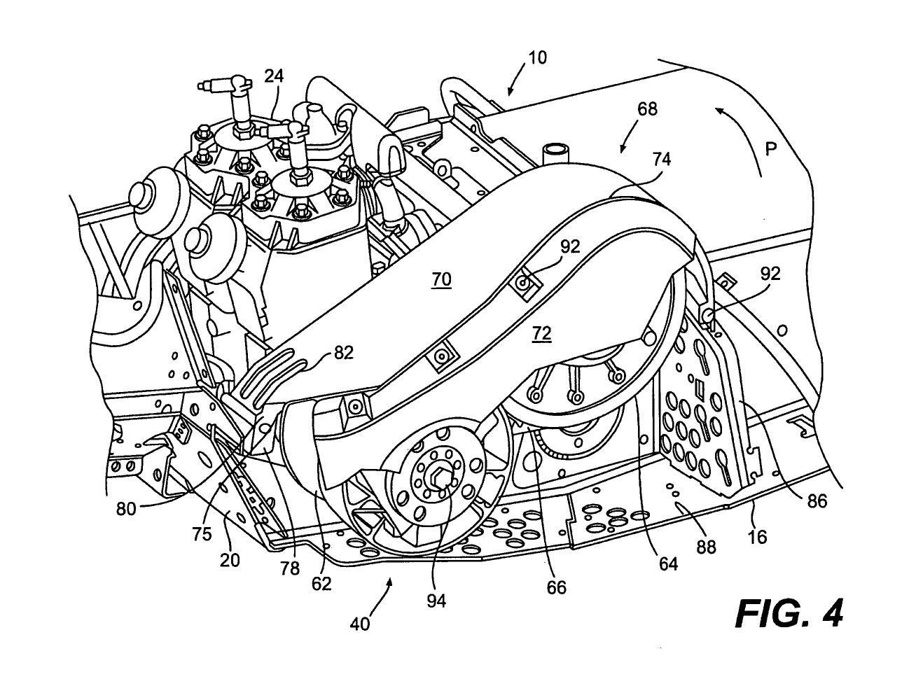

Referring now in detail to the drawings, and primarily to FIGS. 1 and 4, a snowmobile incorporating an embodiment of the present invention is identified generally by the reference numeral 10. Although certain facets of the present invention might be applicable in other types of vehicles, the present invention has particular utility in connection with snowmobiles.

The snowmobile 10 includes a forward end 12 and a rearward end 14 which are defined consistently with the travel direction of the vehicle. The snowmobile 10 includes a chassis 16 which normally includes a rear tunnel 18, an engine cradle portion 20 and a front suspension assembly portion 22. An engine 24 which is schematically illustrated in FIG. 1, is carried by the engine cradle portion 20 of the chassis 16. A ski and steering assembly (not indicated) is provided, in which two skis 26 are positioned at the forward end 12 of the snowmobile 10 and are attached to the front suspension assembly portion 22 of the chassis 16 through a front suspension assembly 28. The front suspension assembly 28 includes ski legs 30, supporting arms 32 and ball joints (not shown) for operatively joining the respective ski legs 30, supporting arms 32 and a steering column 34. The steering column 34 at its upper end is attached to a steering device such as a handlebar 36 which is positioned forward of a rider and behind the engine 24 to rotate the ski legs 30 and thus the skis 26, in order to steer the vehicle.

An endless drive track 38 is positioned at the rear end 14 of the snowmobile 10 and is disposed under tunnel 18, being connected operatively to the engine 24 through a belt transmission system 40 which is schematically illustrated by broken lines in FIG. 1. Thus, the endless drive track 38 is driven to run about a rear suspension assembly 42 for propulsion of the snowmobile 10. The rear suspension assembly 42 includes a pair of slide rails 44 in sliding contact with the endless drive track 38. The rear suspension assembly 42 also includes one or more shock absorbers 46 which may further include a coil spring (not shown) surrounding the individual shock absorbers 46. Front and rear suspension arms 48 and 50 are provided to attach the slide rails 44 to the chassis 16. One or more idler wheels 52 are also provided in the rear suspension assembly 42.

At the front end 12 of the snowmobile 10, there are provided fairings 54 that enclose the engine 24 and the belt transmission system 40, thereby providing an external shell that not only protects the engine 24 and the belt transmission system 40, but can also be decorated to make the snowmobile 10 more aesthetically pleasing. Typically, the fairings 54 include a hood (not indicated) and one or more side panels which are both openable to allow for access to the engine 24 and the belt transmission system 40 when this is required, for example, for inspection or maintenance of the engine 24 and/or the belt transmission system 40. In the particular snowmobile 10 shown in FIG. 1, the side panels can be opened along a vertical axis to swing away from the snowmobile 10. A windshield 56 may be connected to the fairings 54 near the front end 12 of the snowmobile 10 or directly to the handlebar 36. The windshield 56 acts as a wind screen to lessen the force of the air on the rider while the snowmobile 10 is moving.

A seat 58 extends from the rear end 14 of the snowmobile 10 to the fairings 54. A rear portion of the seat 58 may include a storage compartment or can be used to accept a passenger seat (not indicated). Two footrests 60 are positioned on opposed sides of the snowmobile 10 below the seat 58 to accommodate the rider's feet.

The engine 24 is a type of internal combustion engine that is supported on the chassis 16 and is located at the engine cradle portion 20. The internal construction of the engine 24 may be of any known type, however the engine 24 drives an engine output shaft (not shown) that rotates about a horizontally disposed axis that extends generally transversely to a longitudinal centerline 61 of the snowmobile 10. Best seen in FIG. 4, the engine output shaft drives the belt transmission system 40 and in the illustrated embodiment, the belt transmission system 40 includes a drive pulley 62. The drive pulley 62, in turn, drives a driven pulley 64 by way of an endless belt 66 which surrounds the pair of pulleys 62, 64. The driven pulley 64 is, in turn, coupled in an appropriate manner to a drive shaft (not shown) which transmits the torque power generated by the engine 24 in a well known manner, to the endless drive track 38 for propulsion of the snowmobile 10.

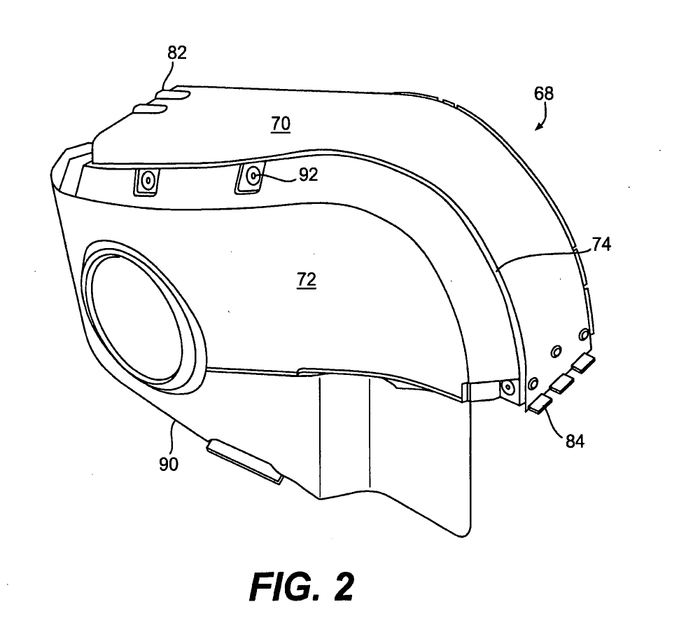

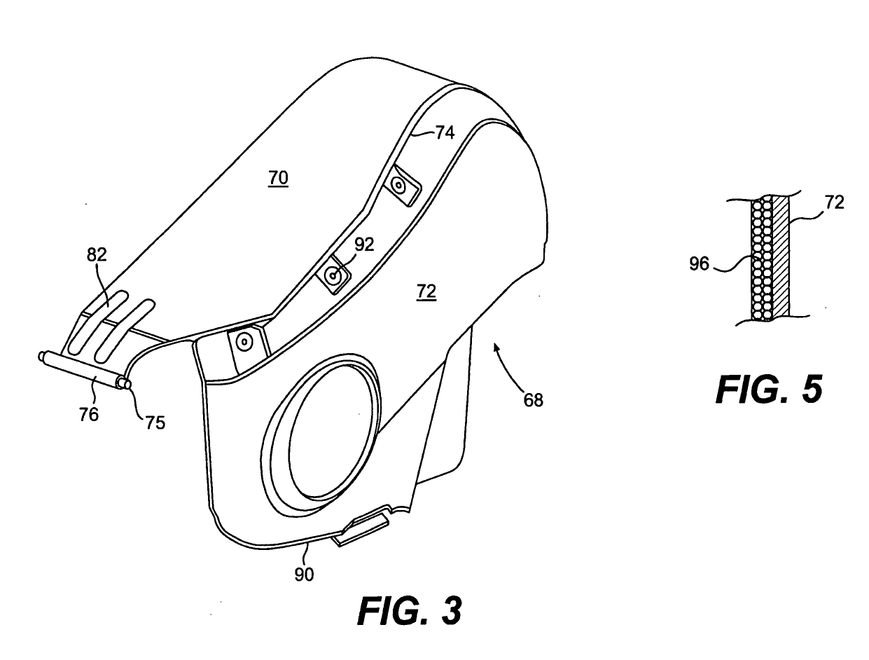

Referring now to FIGS. 2-4, a transmission system cover 68 is provided to prevent pieces of a broken belt from being thrown around in a belt-breaking event, particularly when the hood and side panels of the fairings 54 of FIG. 1 are opened while the engine 24 is running. The transmission system cover 68 includes an upper cover portion 70 preferably made of aluminium. The upper cover portion 70 is formed as an elongate panel and is curved to correspond with the upper contours of the belt transmission system 40. Thus, the upper cover portion 70 can be placed in a close relationship to the belt 66 and the pulleys 62, 64 when being disposed thereabove and being attached to the engine cradle portion 20 of the chassis 16. The upper cover portion 70 when in place, can effectively prevent access to the pulleys 62, 64 and the belt 66 from a top of the snowmobile 10.

The transmission system cover 68 further includes a side cover portion 72 attached to an outside edge 74 of the upper cover portion 70 and extending downwardly therefrom such that access from a side of the snowmobile 10 to the pulleys 62, 64 and the belt 66, is effectively prevented. The side cover portion 72 is preferably made of a plastic material. A pin 75 is received in a sleeve 76 formed at the front end of the upper cover portion 70, with opposed ends projecting laterally therefrom. The opposed laterally projecting ends of the pin 75 are pivotally received in a pair of holes (not indicated) in a bracket 78 which is part of the chassis 16 and is disposed in the engine cradle portion 20 forward of the drive pulley 62. The pin 75 is secured in place by well known fastening mechanisms such as clips 80, and its longitudinal axis extends transversely to the longitudinal centerline 61 of the snowmobile 10 of FIG. 1. Thus, the transmission system cover 68 is permitted to pivot about the pin 75 between a first position (as shown in FIG. 4) in which the upper cover portion 70 is disposed above the belt transmission system 40 and the side cover portion 72 is disposed at an outer side of the belt transmission system 40, and a second position in which the transmission system cover 68 is pivoted away from the first position thereof, as indicated by the arrow P in order to permit access to the belt transmission system 40 when required, for example, when maintenance work needs to be done on the belt 66 and/or the pulleys 62, 64. Optionally, reinforcing ridges 82 can be formed at the front end of the upper cover portion 70 in order to increase the rigidity of the upper cover portion 70.

A plurality of clips 84 are fixed to the rear end of the upper cover portion 70 and are releasably engagable with complimentary components (not shown) disposed on a section of a vertical panel 86 which, as part of the chassis 16, extends upwardly from a bottom surface 88 of the chassis 16 and is disposed immediately behind the driven pulley 64. The clips 84 with their complimentary components provide a means for releasably securing the transmission system cover 68 in the first position. Alternatively, a securing pin (not shown) can replace clips 84 and can selectively lock the rear end of the upper cover portion 70 to the vertical panel 86 with appropriate mechanisms which are well known in the art and will not therefore be further discussed herein. Other well known types of locking devices can also be alternatively used.

The side cover portion 72 has a lower edge 90 positioned to extend to the bottom surface 88 of the chassis 16, preferably as close as possible to the bottom surface 88, when the transmission system cover 68 is in the first position. The side cover portion 72 can be molded with laterally projecting portions or recessed portions to closely correspond to the contours of the belt transmission system 40. Holes (not shown) through the side cover portion 72 are optional. These configurations having holes or projecting portions may be selected in some models of snowmobiles because there is not enough clearance between a flat side cover portion 72 and for example, a nut 94 which affixes the drive pulley 62 to the engine output shaft.

When the snowmobile 10 is running without moving, or especially when it is moving across the ground, the engagement of the belt 66 with the pulleys 62, 64 produces a substantial amount of noise. In conventional snowmobiles, the noise and its reflections off the side of the bottom pan of the snowmobiles can exit through the air vents in the hood.

In order to provide a noise insulation result, the side cover portion 72 is preferably profiled to cover the opening defined between the upper cover portion 70 and the bottom surface 88 of the chassis 16, and between the vertical panel 86 of the chassis 16 and a section of the engine cradle portion 20 which is disposed forwardly of the drive pulley 62 and immediately supports the bracket 78. Preferably, the inner side of the transmission cover 68 includes a noise absorption structure as shown in FIG. 5. For example, a layer of foam material 96 can be attached to the inner side of the side cover portion 72. Optionally, a similar foam layer also can be applied to the inner surface of the upper cover portion 70. Thus, the noise is kept within the space defined by the engine 24, the upper and side cover portions 72, 64, and the chassis 16, and is partially absorbed by the foam layer 96.

The upper cover portion 70 of the illustrated embodiment is made of aluminium, but can be formed of other materials which can adequately bear the impact forces exerted thereupon by the thrown pieces of a broken belt. The plastic side cover portion 72 can be attached to the outer side edge 74 of the upper cover portion 70 by any well known and suitable fastening means. In this particular embodiment, a plurality of bolts 92 are used to bolt the side cover portion 72 together with the upper cover portion 70. Alternatively, the transmission system cover 68 can be made as a single unit, such as an integral cover made from a blank of sheet metal in a pressing process.

The entire transmission system cover 68 is disposed within the external shell of fairings 54 of FIG. 1, and is accessable and pivotally openable when a corresponding side panel of the external shell is opened. When the corresponding side panel of the external shell is opened, the transmission system cover 68 can not only be pivotally opened, but can also be completely removed from the chassis 16 by removing the clips 80 and the pin 74.

Modifications and improvements to the above-described embodiment of the present invention may become apparent to those skilled in the art. The foregoing description is intended to be exemplary rather than limiting. The scope of the present invention is therefore intended to be limited solely by the scope of the appended claims.

1. A pulley cover for covering a belt transmission system of a snowmobile including an endless belt surrounding a pair of spaced-apart pulleys, the pulley cover comprising:
an upper cover portion for preventing access to the pulleys and belt from a top of the snowmobile, the upper cover portion including a releasable connector for releasably connecting the upper cover portion to the snowmobile;
a side cover portion attached to an outer side edge of the upper cover portion and extending downwardly therefrom, for preventing access to the pulleys and belt from a side of the snowmobile when the pulley cover is connected to the snowmobile.

2. The pulley cover as claimed in claim 1, wherein the releasable connector further comprises a pivotal mount, the pivotal mount having a pin constructed and arranged to pivotally interconnect a front end of the upper cover portion and a mounting portion of the snowmobile.

3. The pulley cover as claimed in claim 2, wherein the upper cover portion comprises a locking device located at a rear end thereof for releaseably securing the pulley cover in a closed position.

4. The pulley cover as claimed in claim 1, wherein the upper cover portion is curved corresponding to an upper contour of the belt transmission system.

5. The pulley cover as claimed in claim 1, wherein the upper and side cover portions are integrated as a one-piece part.

6. The pulley cover as claimed in claim 1, wherein the upper cover portion is made of aluminum.

7. The pulley cover as claimed in claim 1, wherein the side cover portion is made of a plastic material.

8. The pulley cover as claimed in claim 1, wherein the side cover portion comprises a noise absorption structure.

9. The pulley cover as claimed in claim 8, wherein the noise absorption structure includes a foam material attached to an inner side of the side cover potion.

10. The pulley cover as claimed in claim 1, wherein the upper cover portion comprises a noise absorption structure.

11. The pulley cover as claimed in claim 10, wherein the noise absorption structure includes a foam material attached to an inner side of the upper cover portion.

12. A snowmobile comprising:
a chassis including a tunnel;
an endless track mounted on the chassis below the tunnel;
an engine mounted on the chassis and operatively connected to the endless track;
a belt transmission system for transmitting power from the engine to the endless drive track assembly, the belt transmission including an endless belt surrounding a pair of spaced-apart pulleys; and
the pulley cover of claim 1, wherein the upper cover potion is releasably connected to the snowmobile via the releasable connector.

13. The snowmobile as claimed in claim 12, wherein the releasable connector further comprises a pivot mount, the pivot mount connecting the pulley cover to the chassis at a front end of the upper cover portion, thereby permitting the pulley cover to pivot about an axis transverse to a longitudinal centerline of the snowmobile between a first position in which the upper cover is disposed above the belt transmission system and the side cover portion is disposed at an outer side of the belt transmission system, and a second position in which the pulley cover is pivoted away from the first position to access the belt transmission system.

14. The snowmobile as claimed in claim 13, wherein the releasable connector further comprises a pin pivotally interconnecting the front end of the upper cover portion and a mounting portion of the snowmobile such that the upper cover portion pivots about the pin.

15. The snowmobile as claimed in claim 14, wherein the pulley cover further comprises a clip device located at a rear end of the upper cover portion for releaseably securing the pulley cover to the chassis when the pulley cover is in a first closed position.

16. The snowmobile as claimed in claim 12, wherein the upper cover portion is shaped corresponding to an upper contour of the belt transmission system.

17. The snowmobile as claimed in claim 12, wherein the side cover portion of the pulley cover comprises a lower edge positioned adjacent a bottom surface of the chassis when the belt transmission system is in a first closed position.

18. The snowmobile as claimed in claim 12, further comprising an external shell for enclosing the engine and belt transmission system, the side cover portion of the pulley cover being disposed between the external shell and the pair of spaced-apart pulleys.

19. The snowmobile as claimed in claim 18, wherein the external shell comprises at least one openable side panel, allowing the pulley cover to pivot to a second open position when required.

20. The snowmobile as claimed in claim 12, wherein the pulley cover further comprises an inner surface at least partially covered with a layer of foam material for noise absorption.
